(19) United States
(12) Patent Application Publication
(10) Pub. No.: US 2010/0180238 A1
(43) Pub. Date: Jul. 15, 2010

(54) USER INTERFACE SYSTEM FOR A PERSONAL HEALTHCARE ENVIRONMENT

(75) Inventors: Gerd Lanfermann, Aachen (DE); Richard Daniel Willmann, Siegburg (DE); Andreas Brauers, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/063,725

(22) PCT Filed: Aug. 3, 2006
(86) PCT No.: PCT/IB06/52669

§ 371 Date: Feb. 13, 2008

(30) Foreign Application Priority Data
Aug. 15, 2005 (EP) 05107469.8

(51) Int. Cl. G06F 3/01

(52) U.S. Cl. 715/865

(57) ABSTRACT

The present invention relates to a user interface system for a personal healthcare environment. Furthermore the invention relates to a method of operating such a user interface system. In order to provide a user interface system which can easily be used by disabled users, a user interface system (1) is suggested, comprising a number of user interface components (2, 3, 4), and further comprising an adaptation module (5), said adaptation module (5) being adapted to carry out an automatic adaptation of at least one of the components (2, 3, 4) based on the disabilities of an individual user.

The present invention relates to a user interface system for a personal healthcare environment. Furthermore the invention relates to a method of operating such a user interface system.

User interfaces are a crucial element for all personal healthcare devices and platforms. Current user interfaces remain fixed in terms of appearance once they have been designed and configured. However, some features of the interface may be changed manually by the user himself or by another person. If, for example, the user interface comprises a display, the font size, the size of the computer mouse or the mouse speed may be changed. Such changes can be carried out as part of the so-called system configuration. Furthermore magnifying glasses can be used by the visually impaired. If, for example, the user interface comprises a speech capability, the playback speed may be increased or decreased as part of the system configuration.

From the international patent application WO 03/081414 A1 an adaptable interface with different levels of complexity is known. However, the modification of the interface has to be realized manually. This and all other known solutions of adapting a user interface are highly inflexible and hard to adapt to the needs of a disabled user.

It is an object of the present invention to provide a user interface system which can easily be used by disabled users.

This object is achieved according to the invention by a user interface system for a personal healthcare environment, comprising a number of user interface components, and further comprising an adaptation module, said adaptation module being adapted to carry out an automatic adaptation of at least one of the components based on the disabilities of an individual user.

The object of the present invention is also achieved by a method of operating a user interface system for a personal healthcare environment, said user interface system comprising a number of user interface components, the method comprising the step of automatically adapting at least one of the components based on the disabilities of an individual user.

The object of the present invention is also achieved by a computer program for operating a user interface system for a personal healthcare environment, said user interface system comprising a number of user interface components, the program comprising computer instructions to automatically adapt at least one of the components based on the disabilities of an individual user, when the computer program is executed in a computer. The technical effects necessary according to the invention can thus be realized on the basis of the instructions of the computer program in accordance with the invention. Such a computer program can be stored on a carrier such as a CD-ROM or it can be available over the Internet or another computer network. Prior to execution, the computer program is loaded into the computer by reading the computer program from the carrier, for example by means of a CD-ROM player, or from the Internet, and storing it in the memory of the computer. The computer includes inter alia a central processor unit (CPU), a bus system, memory means, e.g. RAM or ROM etc., storage means, e.g. floppy disk or hard disk units etc., and input/output units. Alternatively the inventive method could be implemented in hardware, e. g. using one or more integrated circuits.

A core idea of the invention is to provide a user interface system, in which no manual configuration is necessary in order to adapt the interface handling. Instead it is suggested to adapt the user interface automatically and individually. The user's requirements for a user interface change with the progression of a disability or the improvement of a condition on one hand, and the interface familiarity, which a user develops over time, on the other hand.

The user interface system according to the invention can be used for all kinds of personal healthcare devices and systems, for example for telemedicine services for rehabilitation and chronic conditions, diabetes monitoring systems or cardiac training devices (e.g. bikes) that feature information input and output through a display.

Typical disabilities covered by the user interface system according to the invention are: hearing problems, motor deficits in the arms, cognitive problems (slow thinking and comprehension) and visual deficits (color blindness), and progressive deficits caused by aging.

The user interface system will e.g. take the hearing disabilities of users into account and tune the playback of a text-to-speech system to maximize the comprehension. To ensure legibility for visually impaired users, the font size in a screen menu is enlarged initially, and when the user's reaction indicates familiarity with the interface the font size may later be decreased for the sake of visibility. Other components which can be modified are sentence speed, sentence complexity, vocabulary scope, repetition of phrases, pauses, visual contrast and coloring, among others.

The system according to the present invention will be adapted to the user's requirements on the course of a progressive disease and during rehabilitation. In other words, with the present invention a solution is also given to the problem which arises when users become acquainted with the system. In this case the inventive solution allows the system to automatically reduce the degree of enhancement.

These and other aspects of the invention will be further elaborated on the basis of the following embodiments which are defined in the dependent claims.

According to a preferred embodiment of the invention the adaptation is carried out based on user data, which has been provided to the system before and/or which has been retrieved by the system. For this purpose the user interface system preferably comprises a database module adapted to provide user data to the adaptation module. In other words, in a first step, the user interface is configured in such a way that the user will be able to use the system. The configuration is based on the diagnosed disability, which may be retrieved from the database. Such settings are usually very conservative and they provide a large degree of enhancement over a normal interface: the font size is big and the playback speed of a text-to-speech system is slow, whereas sentence complexity is moderate.

According to another preferred embodiment of the invention the adaptation is carried out based on the user's operating performance. For this purpose the user interface system preferably comprises a performance module adapted to measure the user's operating performance and further adapted to provide the results of said measurements to the adaptation module. The adaptation may then be performed based on the current user performance However, prior measurements may also be taken into account. Accordingly the adaptation may also be carried out based on a change of the user's operating performance, i.e. a performance trend is determined and the new settings are determined based on the evaluation of this trend. That is, current measurements are evaluated based on the results of prior measurements. According to yet another preferred embodiment the adaptation is carried out based on the user's reaction to a previous adaptation of the user interface. With this above-described embodiment a dynamically adapting and “self-learning” system is provided. In other words, in a second step, which may last over a longer period of time, e.g. several weeks, depending on interface usage, the system optimizes the user interface settings. The user interface system gradually reduces the degree of enhancement: font size is decreased, text-to-speech playback is faster, and sentence complexity may vary. The system measures the reaction of the user to these changes. The system may also take the device usage pattern into account, where reduced usage may be caused by the reduced ability of the patient to operate the user interface. According to yet another preferred embodiment an adaptation is reversed if the operating performance of the user deteriorates. Optionally another adaptation is carried out instead.

The invention describes a user interface system in a personal healthcare environment, which uses diagnosed patient disabilities and patient reactions to adapt user interface components in order to improve the interface interaction, even as disabilities progress. In particular, the user interface dynamically and specifically adapts to the individual disabilities of users. Thereby the testing of the user's performance is not carried out separately (e.g. during a separate test procedure), but during the normal use of the user interface.

These and other aspects of the invention will be described in detail hereinafter, by way of example, with reference to the following embodiments and the accompanying drawings; in which:

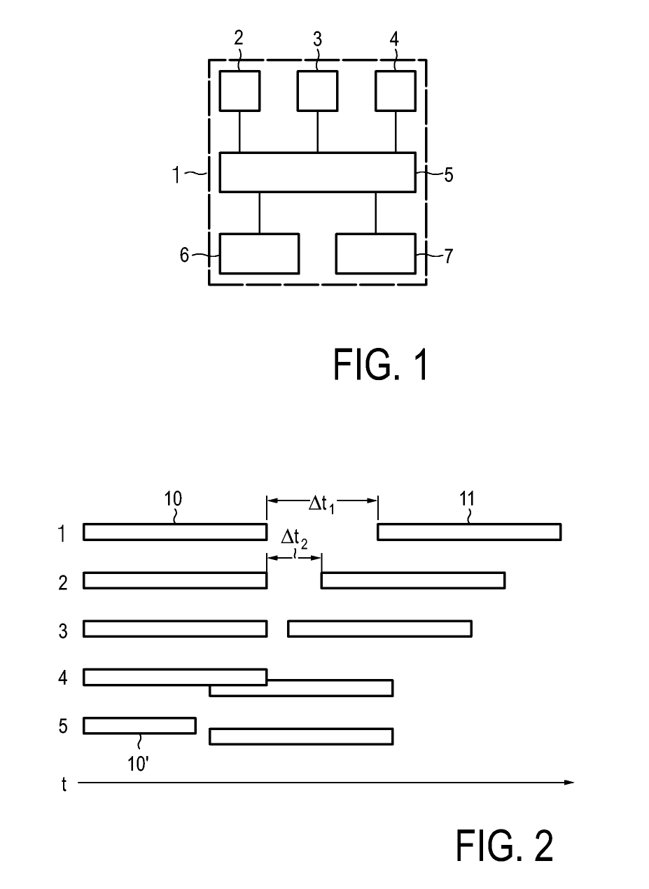

FIG. 1 shows a schematic block diagram of a user interface system,

FIG. 2 shows a modification pattern based on the user's response time,

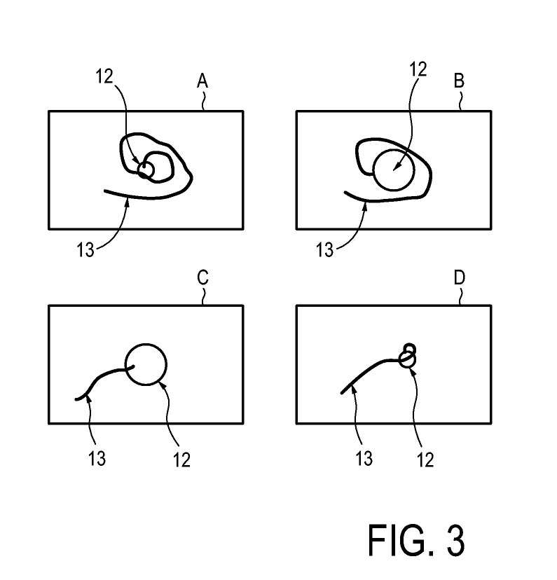

FIG. 3 shows a modification pattern based on the user's performance by clicking a button.

As an example, a user interface system 1 is described, which is used for a home-based personal healthcare device, such as the Philips Motiva System for monitoring patients with chronic cardiac conditions.

The user interface system 1 comprises a computer. Said computer comprises a number of functional modules or units, which are implemented in the form of hardware, software or in the form of a combination of both. Thus, the present invention can be implemented in the form of hardware and/or software.

Among others, the user interface system 1 comprises a number of user interface components, e.g. a display 2, a text-to-speech system 3, and a mouse input device 4. All components are connected to an adaptation module 5. The adaptation module 5 is preferably implemented in the form of a software module. The adaptation module 5 automatically adapts at least one of the components 2, 3, 4 based on the disabilities of an individual user. For automatic adaptation the adaptation module 5 processes information about the specific disability of the individual user. Such information is provided to the adaptation module 5 in the form of data, which has been diagnosed prior to adaptation or which is diagnosed immediately before the adaptation is performed. For this purpose the user interface system 1 comprises a database module 6 from which the user information is retrieved and transmitted to the adaptation module 5. Optionally the user interface system 1 may comprise a diagnosing module (not shown) for providing data based on an immediate diagnosis of the user.

In order to use the user interface system 1, a user is requested to perform an identification task. For this purpose a variety of different mechanisms may be used, e.g. visual/speech identification, login and passwords, or ID card. When the user accesses the system 1 for the first time, the database module 6 retrieves the disabilities of the user from a repository, e.g. from a medical backend (e.g. via a communication line not shown) or from the user's ID card. The disabilities have been diagnosed and graded beforehand. In a next step the user information is stored in the database module 6.

The adaptation module 5 of the system 1 then automatically implements the interface settings that are associated with the type and degree of disability, i.e. the adaptation module 5 adapts the user interface components 2, 3, 4 accordingly. Thereby the following mapping mechanism may be used: in case of visual impairment: large font, enable voice input, normal voice speed; in case of a blind user: no screen output, enable voice output; in case of a hearing disabled user: normal font, enable voice output, slow voice speed, high volume; in case of a deaf user: normal font, disable voice output; and in case of a user with cognitive problems: normal font, enable voice, low sentence complexity, low sentence variability (highly repetitive to ensure comprehension). The user may optionally modify the suggested disabilities and their implications. Combinations of the mappings are possible: e.g. hearing disability and cognitive impairments.

The user interface system 1 further comprises a performance module 7, adapted to measure the user's operating performance and further adapted to provide the results of said measurements to the adaptation module 5. Again, the performance module 7 is preferably implemented in the form of a software module. The performance module 7 is adapted to detect and process the user's operating behavior, the user's behavior patterns, and the user's performance trend, and is further adapted to assess the user's performance Based on the results of the performance module 7, which are transferred to the adaptation module 5, the adaptation module 5 automatically carries out the adaptation according to the user's operating performance, thereby automatically taking into account the user's disabilities.

The performance module 7 can also be adapted to provide a long-term performance test, wherein the automatic adaptation of the user interface components 2, 3, 4 is carried out based on the user's reaction to a previous adaptation of the user interface, as illustrated in FIGS. 2 and 3.

As illustrated in FIG. 2, the interface can for example be optimized with regard to the length of a question or an instruction which is directed to the user. In other words, if the user is given a question or instruction, the performance module 7 times the duration until the user reacts to the instruction. In FIG. 2 the duration of questions/instructions 10 and answers/reactions 11 as well as the response times Δt are illustrated. In a first test, which is denoted “1” in FIG. 2, the user requires the time period of Δt₁ for providing an answer/reaction 10 upon a question/instruction 11 of the user interface system 1. In a second test “2” the user's response time Δt₂<Δt₁ has been decreased. In test “3” the answer/reaction 11 has been given even more quickly and in test “4” the answer/reaction 11 has been given before the complete question/instruction 10 has been provided to the user, i.e. before the question sequence has ended. The tests “1” to “4” have been performed for example each time the user started the user interface system 1. As the performance module 7 determines that in test “4” a predefined condition for adaptation is fulfilled, the adaptation module 5 automatically changes the length of the question/instruction 10′, see test “5”. In other words the question/instruction-phrasing, i.e. the question process, is abbreviated if the user's reaction is shorter then a pre-set or learned threshold. This can be done e.g. by shortening the question 10′ or by increasing the playback speed. Additionally the correctness of the user's answers/reactions during the tests “1” to “4” may be taken into account for assessing the user's performance and for making the decision as to whether or not the question process is to be abbreviated.

In FIG. 3 another modification pattern is illustrated. A user with motor deficits is instructed to click on a button 12 using the mouse input device 4. The line towards the button 12 indicates the pointer's trajectory 13. In a first test (section A) the medium-sized button 12 is hit by the user after a relatively long period of trying, illustrated by the long pointer trajectory 13. This user performance is measured by the performance module 7 and the results of those measurements are transferred to the adaptation module 5. As a result the adaptation module 5 changes the size of the button 12 for a subsequent test. In other words, the button 12 is enlarged based on a diagnosed motor deficit test (section B). Some time later, once the user is familiar with the mouse pointer handling, as can be seen by the very short trajectory 13 in the test (section C), the button size is decreased again by means of the adaptation module 5, see the subsequent test (section D). Such a performance test can also be carried out for dynamically adapting size, color etc. of all kinds of visual interaction components, e.g. buttons, menu bars, navigation elements etc. Fast and concise movements indicate familiarity with the system, while erratic movements indicate a lack of familiarity with the interface. In the latter case, the following steps may be taken: simplifying the visual interaction components, e g simplifying the menu structure, and increasing the amount of help.

In another embodiment of the invention the performance module 7 is adapted to perform an error detection. For example the number of corrections are detected, e.g. when the user selects a wrong menu item or loses himself in the menu structure. As a result the menu structure is simplified accordingly by means of the adaptation module 5.

In another embodiment of the invention the performance module 7 is adapted to detect facial expressions of the user. That is, the system may detect whether the user appears to be puzzled, which may be indicated by the user raising the eyebrows or rolling the eyes or starting to talk to himself.

If the performance module 7 detects that the user has problems with the interface, e.g. because of an increasing error rate (correcting choices, long reaction times etc.), a previously made modification is reversed to a more conservative, safer setting. Users without disabilities may use the system 1 as well. In this case the system 1 may operate without the use of the database module 6.

The user interface system 1 according to the invention may be used as a therapeutic measure. For this purpose the adaptation module 5 adapts the interface components 2, 3, 4 in such a way that the adjusted level of difficulty or complexity for the user is slightly above the level which is easily manageable for the user. In other words, a demanding level of complexity is set in order to provide a challenge to the user. This challenge serves as a therapeutic moment during rehabilitation.

The user interface system 1 is adapted to perform all tasks of calculating and computing user-related data as well as determining and assessing results and adapting the user interface components 2, 3, 4. This is achieved by means of computer software comprising computer instructions adapted for carrying out the steps of the inventive method, when the software is executed in the computer as integrated in the user interface system 1.

It will be evident to those skilled in the art that the invention is not limited to the details of the foregoing illustrative embodiments, and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. It will furthermore be evident that the word “comprising” does not exclude other elements or steps, that the words “a” or “an” do not exclude a plurality, and that a single element, such as a computer system or another unit may fulfill the functions of several means recited in the claims. Any reference signs in the claims shall not be construed as limiting the claim concerned.

Reference Signs
1 user interface system
2 display
3 text-to-speech system
4 mouse input device
5 adaptation module
6 database module
7 performance module
8 (free)
9 (free)
10 question/instruction
11 answer/reaction
12 button
13 trajectory

1. A user interface system (1) for a personal healthcare environment, comprising a number of user interface components (2, 3, 4), and further comprising an adaptation module (5), said adaptation module (5) being adapted to carry out an automatic adaptation of at least one of the components (2, 3, 4) based on the disabilities of an individual user.

2. A user interface system (1) as claimed in claim 1, further comprising a database module (6) adapted to provide user data to the adaptation module (5).

3. A user interface system (1) as claimed in claim 1, further comprising a performance module (7) adapted to measure the user's individual operating performance and further adapted to provide the results of said measurements to the adaptation module (5).

4. A method of operating a user interface system (1) for a personal healthcare environment, said user interface system (1) comprising a number of user interface components (2, 3, 4), the method comprising the step of automatically adapting at least one of the components (2, 3, 4) based on the disabilities of an individual user.

5. A method as claimed in claim 4, characterized in that the adaptation is carried out based on user data, which has been provided to the system (1) before and/or which has been retrieved by the system (1).

6. A method as claimed in claim 4, characterized in that the adaptation is carried out based on the user's operating performance.

7. A method as claimed in claim 4, characterized in that the adaptation is carried out based on a change of the user's operating performance.

8. A method as claimed in claim 4, characterized in that the adaptation is carried out based on the user's reaction to a previous adaptation of the user interface components (2, 3, 4).

9. A method as claimed in claim 4, characterized in that an adaptation is reversed if the operating performance of the user deteriorates.

10. A computer program for operating a user interface system (1) for a personal healthcare environment, said user interface system (1) comprising a number of user interface components (2, 3, 4), the program comprising computer instructions to automatically adapt at least one of the components (2, 3, 4) based on the disabilities of an individual user, when the computer program is executed in a computer.
